(19) United States
(12) Patent Application Publication
(10) Pub. No.: US 2010/0146683 A1
(43) Pub. Date: Jun. 17, 2010

(54) Quick Release Fastener

(76) Inventor: Shlomo Laniado, Tel-aviv (IL)

Correspondence Address: THE NATH LAW GROUP, 112 South West Street, Alexandria, VA, 22314, US

(21) Appl. No.: 11/991,843

(22) PCT Filed: Sep. 14, 2006
(86) PCT No.: PCT/IL2006/001077

§ 371 Date: Mar. 12, 2008

(30) Foreign Application Priority Data
Sep. 15, 2005 (US) 11/226438

(51) Int. Cl. A41D 27/00; A43C 11/00; A44B 11/02; E04H 17/20; G01L 5/04

(52) U.S. Cl. 2/243.1; 36/50.1; 24/265 R; 24/68 BT; 256/65.03; 73/862.391

(57) ABSTRACT

A fastener comprising a cylindrical member connected to a first strap section along the cylinder's wall, a tube-shaped member connected to a second strap section along the tube's wall. The tube has an opening within its wall to allow the passage of the first strap therethrough, and may comprise a display window covered with a magnifying glass to allow the assessment of the relative tension between the two opposing straps. The first strap section is attached to the second strap section by inserting the cylinder in the tube. The fastener is adapted to be brought to a fastened state in which the first strap and second strap are connected via the fastener at a desired tension and an unfastened state in which the first strap and second strap are separated

### FIELD OF THE INVENTION

This invention relates to a fastener and, more particularly, to a fastener adapted for joining and tensioning two strap-like sections and facilitating quick release thereof.

### BACKGROUND OF THE INVENTION

Fasteners for strap-like objects are well known. Such fasteners may be, for example, seat-belt buckles or buttons which facilitate quick attachment and detachment of strap-like portions of an object. Fasteners may also be used to alter the length of strap and the tension between the objects that are connected thereby. Fasteners for attaching strap-like sections may also be used with a variety of clothing and non-clothing items, examples of which may be the straps of a harness of a backpack or the straps of a shoe, etc.

### SUMMARY OF THE INVENTION

The objective of the invention is to provide a quick attachment/detachment fastener which by rotation adjustment allows tensioning of objects connected via the fastener.

According to a first aspect of the invention, there is provided:

A fastener for joining a first strap section and a second strap section, the fastener comprising a cylindrical member connected to said first strap section, a tube-shaped member connected to said second strap section, said tube having an opening formed its wall to allow the passage of the first strap therethrough and having an inner diameter larger than the diameter of the cylinder such that the cylinder is insertable into a lumen of the tube and rotatable thereinside.

The arrangement is such that the first strap section is coupled to the second strap section by inserting the cylinder almost completely into the tube and winding the first strap about the cylinder to a desired tension. The fastener is adapted to be then brought to a fastened state by full insertion of the cylinder into the tube, in which it is retained and in which the first strap section and second strap section are connected via the fastener at a desired tension, and returned to an unfastened state by removal of the cylinder from the tube by application of a single pulling motion, constituting a “quick release” of the fastener.

Both members of the fastener, namely the cylindrical member and the tube-shaped member are coaxial and have parallel wall surfaces. According to some particular embodiments, they are both cylindrical.

It should be noted that these two strap sections (which may be formed, for example, as belt-like-shaped sections or cord-like-shaped sections) can be either two different sections of the same strap or two sections of two different straps. Furthermore, to aid the fastener to maintain the fastened state at a desired tension, at least a portion of a surface of the first strap may have a friction texture, and/or may have periodic bulging portions, and/or the inner surface of the tube may include a friction surface, e.g. in the form of pliable teeth. If the fastener comprises pliable teeth, the cylinder, when in fastened position, may be rotated in one direction only.

The fastener may include a knob at one end or both ends of the cylinder to facilitate gripping and manual rotation of the cylinder, thereby winding the first strap section around a longitudinal axis of the cylinder, or to provide snapping engagement to the tube in the fastened state when the cylinder is inserted in the tube. The knob, at one respective end of the cylinder, may be tapered and thereby adapted for increased friction engagement with the inner wall surface of the tube, The knob may be of any shape which allows easy rotation thereof by a user.

The fastener may comprise a tension indicator having a scale for displaying the associated tension between the first strap section and second strap section. The scale will typically be imparted over one or both faces of the first strap and may be in different forms on indicia, e.g. a numerical scale, a color scale, a pictorial scale, a word scale, etc. The numerical scale is oriented in accordance to the object that the fastener is attached to, for facilitating reading thereof. For example, if the fastener is used to tighten shoe straps, the scale may be upside down with respect to the floor, to allow a person wearing the shoes to look down at them and to read the scale in a normal reading orientation. Alternatively, in such a case the scale may be oriented parallel with the floor. Additionally, the fastener may comprise a display window for viewing the scale formed on an external surface of the tube member. The display window may include a magnifying glass. Alternatively, the scale may be formed on the knob with an appropriate pointer marked on the tubular member.

The fastener may be adapted to be used with a variety of items, setting as examples items such as garments (e.g. belts or shoes), bags and backpacks, a harness, securing elements, or other similar constructions which comprise strap-like portions that require fastening and tensioning a fence of an adjustable length etc. If the fastener is used for shoes, the fastener size and orientation may be adapted for different types of shoes. For example, sports shoes may use a smaller lighter embodiment of the fastener, whereas boots may use a larger more rugged heavy-duty embodiment of the fastener. The orientation of the fastener with respect to the object being fastened may vary in accordance with the type of object being fastened. For example, regarding the above-mentioned sports shoes and boots, the longitudinal axis of the fastener used with the sports shoes may project in a direction normal to the outer surface thereof, whereas the longitudinal axis of the fastener used with the boot may be parallel to the outer surface thereof. If for example, the fastener is part of a fence, it should be noted that the posts of the fence may be configured as the fastener. Furthermore, the posts may comprise a bottom part which is hermetically sealed along the circumference of the bottom part.

According to an aspect of the invention there is provided an article fitted with a fastener as hereinabove disclosed. According to still another aspect of the invention there is provide an object comprising at least two fasteners, of the type described above, wherein the fasteners are disposed in an arrangement which allows the object to be detachably attached from the object and then reattached to the object or to other items via the fasteners.

The opening formed within the wall of the tube may be in the form of a longitudinal slit allowing longitudinal insertion of the first strap section or it may be in the form of an aperture. If the opening is a longitudinal slit, it may be formed in the tube such that it extends the entire length of the tube or a major portion thereof, in which case there will be a reinforcing portion adjacent one of its respective ends.

The invention provides a fastener for joining a first strap section and a second strap section, the fastener comprising a winding member connected to said first strap section, and tubular receptacle member connected to said second strap section and having an inner diameter larger than the diameter of the winding member for rotatably accommodating the winding member; the receptacle member having an opening formed at a wall to allow passage of the first strap therethrough, whereby the first strap section is attached to the second strap section by inserting the winding member into the receptacle member and winding it to a fastened state at a desired tension and length.

The fastener may further have a locking mechanism for maintaining or assisting to maintain the fastener in a tensioned-fastened state. The locking mechanism may be a rotatable member, mounted inside the tube. The locking mechanism may have an opening formed therein for the first strap to pass therethrough. The opening in the locking mechanism may be a slit or an aperture. If the opening is an aperture, it may include a tapered section which can be used to clamp the first strap when the mechanism is rotated with respect to the tube. The mechanism may be formed in such a way as to provide snapping engagement to the cylinder and/or the tube, in which case the tube may be formed accordingly to enable the snapping engagement, in the fastened state when the cylinder is inserted in the tube. Furthermore, the inner surface of the locking mechanism may include a friction surface, e.g. in the form of pliable teeth, that allowing the rotation of the cylinder in one direction only. The mechanism may comprise a position indicator for aiding insertion and/or withdrawal of the cylinder from the mechanism and/or tube. The position indicator may be in the form of a line on the outer surface of the mechanism. The mechanism may also comprise a display window through which the tension indicator and position indicator may be seen.

The fastener may have a flat round configuration with a flat rotating wheel to fit the flat surface of the fastener allowing the tapering portion of the strap to be wound around the short axis connected to the rotating wheel.

There has thus been outlined, rather broadly, the more important features of the invention so that the detailed description thereof that follows hereinafter may be better understood, and the present contribution to the art may be better appreciated. Additional details and advantages of the invention will be set forth in the detailed description.

### BRIEF DESCRIPTION OF THE DRAWINGS

In order to better understand the invention and to see how it may be carried out in practice, several embodiments will now be described, by way of non-limiting examples only, in which:

FIGS. 1A and 1B are perspective views of a fastener, according to a first embodiment of the present invention, in the unfastened/detached and fastened/attached states, respectively.

FIG. 2 is a cross-sectional view of a rotation adjusted fastener across the plane ‘A’ in FIG. 1B;

FIG. 3 illustrates the utilization of a rotation adjusted fastener of the present invention for fastening a belt for trousers;

FIG. 4A illustrates an example of a fastener of the present invention for fastening straps of a shoe;

FIG. 4B illustrates another example of a rotation adjusted fastener for fastening straps of a sports shoe, further including a tension indicator, in an unfastened state;

FIG. 4C illustrates the fastener shown in FIG. 4B, in a fastened, tensioned state;

FIG. 4D illustrates another example of a fastener for fastening straps of a boot, further including a display window, in an unfastened state;

FIG. 4E illustrates the boot and fastener shown in FIG. 4D, in a fastened, tensioned state;

FIG. 5 is a rear perspective view of a backpack having harness straps which are connected by two fasteners according to the present invention;

FIG. 6 is a schematic perspective view of a portion of an exemplary fence fitted with fasteners according to the present invention;

FIG. 7 is a cross-sectional view taken along line XII-XII in FIG. 6, according to an embodiment of the invention;

FIG. 8 illustrates an example of application of the fence of the present invention for building a wall of a pool;

FIG. 9A is an exploded isometric view of a further example of a fastener, comprising a locking mechanism;

FIG. 9B illustrates the fastener shown in FIG. 9A, rotated to show the tension indicator, position indicator and display window;

FIG. 9C is a side perspective view of the fastener shown in FIGS. 9A and 9B, almost in fastened position, with an enlarged view of the portion which enables the snapping engagement thereof;

FIG. 9D is a side perspective view of the fastener shown in FIGS. 9A-9C, in fastened position, but not yet with the straps under tension;

FIG. 9E is a side perspective view of the fastener shown in FIGS. 9A-9D, in fastened position, with the straps under tension;

FIG. 9F is a side perspective view of the fastener shown in FIGS. 9A-9E, in fastened position, with the straps under tension and the locking mechanism in a locked state;

FIG. 10A is a top exploded view of yet a further example of a fastener, which comprises a shortened cylinder;

FIG. 10B is a bottom exploded view of the fastener shown in FIG. 10A;

FIG. 10C is a bottom perspective view of the fastener shown in FIGS. 10A and 10B;

FIG. 10D is a partial top perspective view of the fastener shown in FIGS. 10A-10C, with the straps under tension;

FIG. 10E is a side perspective view of the fastener shown in FIGS. 10A-10D, in an unlocked state;

FIG. 10F is a side perspective view of the fastener shown in FIGS. 10A-10E, in a locked state;

FIG. 10G is a side perspective view of the fastener shown in FIGS. 10A-10F, in a locked state;

FIG. 10G illustrates a side perspective view of the fastener shown in FIGS. 10A-10F, in a locked state, for fastening straps of a shoe;

FIG. 11A is a side perspective view of another example of a fastener, in an unfastened state; and

FIG. 11B is a partial top perspective view of the fastener shown in FIG. 11A, with the straps under tension.

### DETAILED DESCRIPTION OF EXEMPLARY EMBODIMENTS

The principles and operation of a fastener according to the present invention may be better understood with reference to the accompanying description and the drawings, in which embodiments of the invention are illustrated. It should be understood that these drawings are given for illustrative purposes only and are not meant to be limiting. The present invention may be embodied in many different forms and should not be construed as limited to the embodiments set forth herein.

A fastener according to the present invention, as will become apparent hereinafter provides quick and secure attachment between two apposing strap-like sections with the option of markedly quick release. It should be noted that these two strap-like sections can be, for example, two different sections of the same strap (or belt) or two sections of two different straps (or belts). Still, the fastener according to the present invention provides tensioning of the fastened coupling to a desired extent.

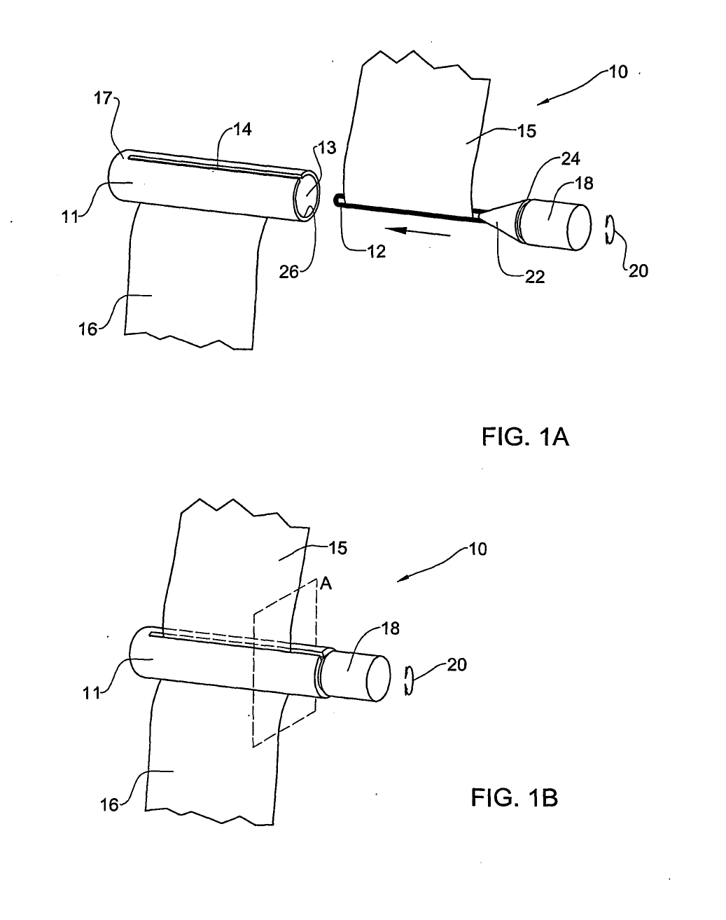

Referring first to FIGS. 1A and 1B there is illustrated a fastener according to a first embodiment of the invention, generally designated 10, illustrated in the unfastened (also referred to as ‘detached’) and fastened (also referred to as ‘attached’) states, respectively.

The rotationally adjustable fastener 10 includes a tube-shaped member 11 and a cylinder 12 having a diameter smaller than the inner diameter of the tube 11, to provide that the cylinder 12 can easily slide into the lumen 13 of the tube 11. Thus, the cylinder 12 defines a “male” part of the fastener 10, whereas the tube 11 defines a “female” part of the fastener 10, correspondingly. The cylinder 12, along its cylinder wall, is connected to a section (e.g., an edge) of a first strap (or belt) 15. The tube 11, along its wall, is connected to a second strap (or belt) 16. In this example, the place of this connection is selected on the region of the wall which is diametrically opposite to an opening formed within the tube in the form of a longitudinal slit 14. The straight longitudinal slit 14 is formed along a major portion of the wall of the tube 11, to allow insertion and substantially smooth passage of the first strap 15 therethrough when inserting the cylinder 12 into the tube 11 (FIG. 1B).

In the present embodiment the slit 14 extends along a major portion of the tube 11, with a tube reinforcing segment 17. However, according to an other embodiment (not shown), the slit extends the entire length of the tube. This arrangement however, requires that the tube 11 be of sufficient strength to endure forces applied thereto during tensioning of the fastener, so as to avoid deformation thereof.

The cylinder 12 on one of its ends is equipped with a knob (or button) 18 that enables firm manual grip and rotation of the cylinder 12.

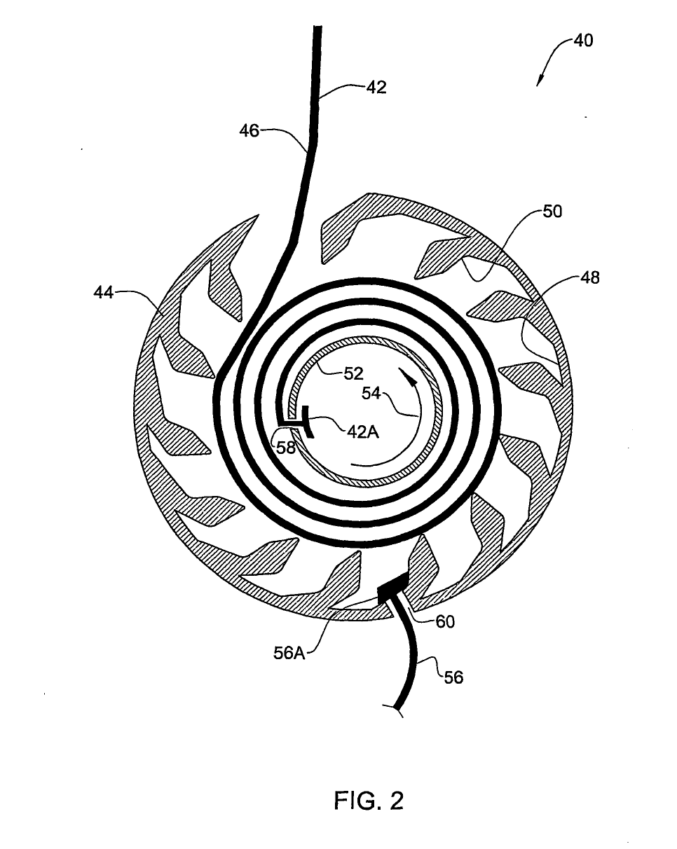

Once received within the tube 11, rotation of the cylinder 12 in either direction indicated by the arrow 20 in FIGS. 1A and 1B, winds the first strap 15 around the longitudinal axis of the cylinder 12, thereby reducing the redundant extra length of the strap 15 as it is wrapped around the cylinder 12, and when done while the cylinder 12 is inside the tube 11, the tension between the two strap members is increased to a desired extent. It is appreciated that according to a basic embodiment of the invention, the cylinder 12 may be rotated in either direction for winding the strap 15. However, according to some particular embodiments of the invention, rotation is facilitated in one direction only, by the provision of teeth or other elements configured to allow the rotation of the cylinder 12 in one direction only (as illustrated for example in connection with the embodiment of FIG. 2).

In the unfastened state, the male and female parts of the fastener 10 are separated. Upon fastening, the male part 12 is introduced into the female part 11, such that the first strap 15 slides through the slit 14. The male part 12 is then rotated to tension the straps 15 and 16. In order to avoid release of the male from the female part under pull, the knob 18 has a tapered portion 22. By a gentle push on the knob 18 inward, the tapered part 22 entering the tube 11 will provide friction connection between the inner surface of the tube 11 and the tapered part 22, thereby enforcing the friction therebetween, to avoid incidental separation of the male and female parts, i.e., thereby constituting the fastened state.

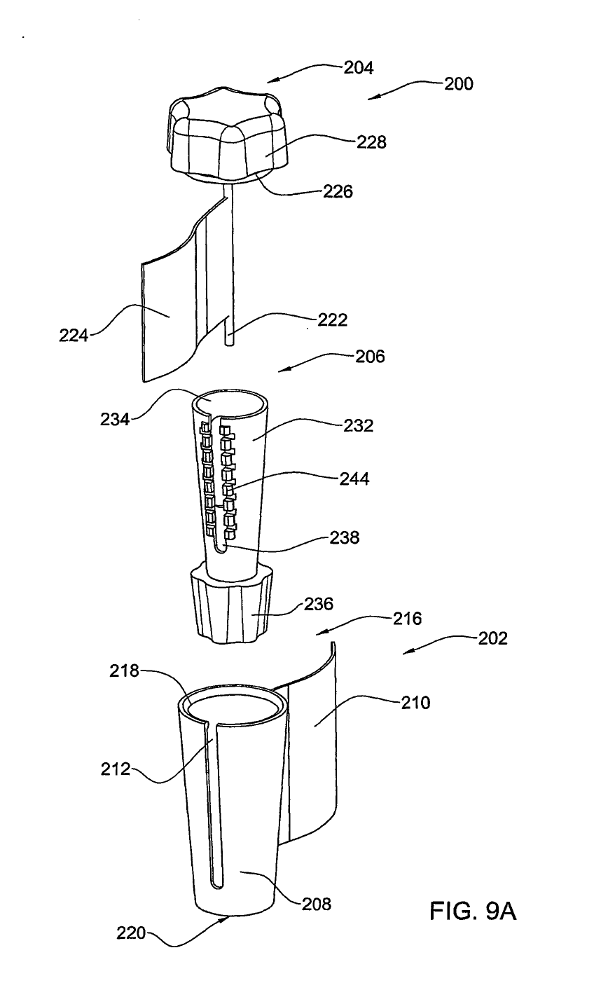

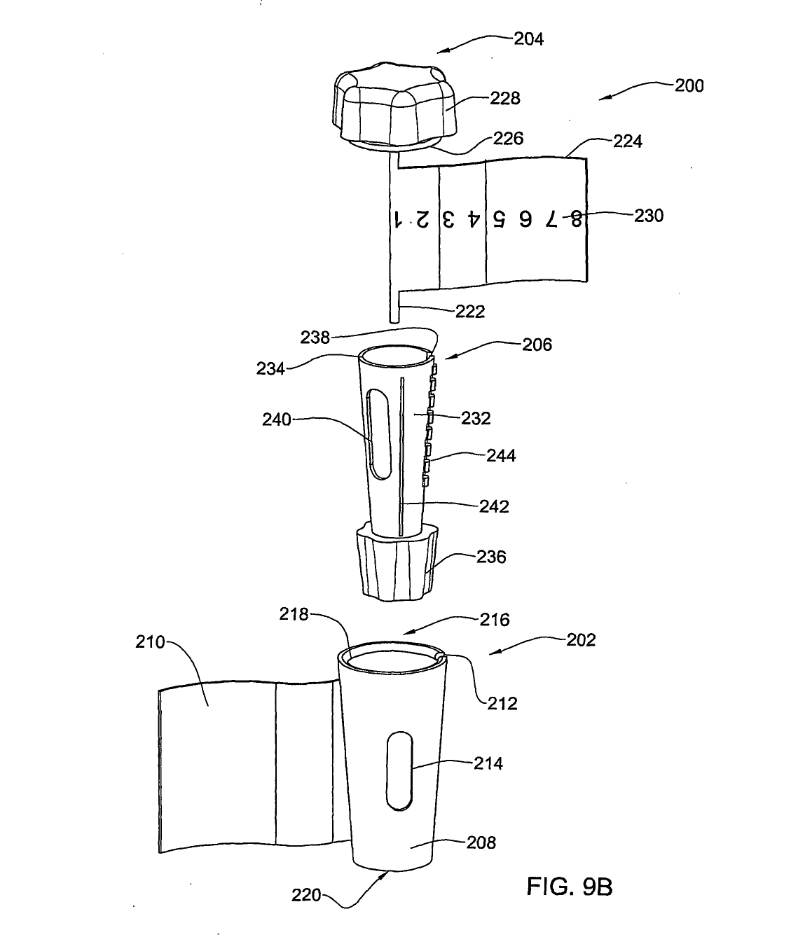

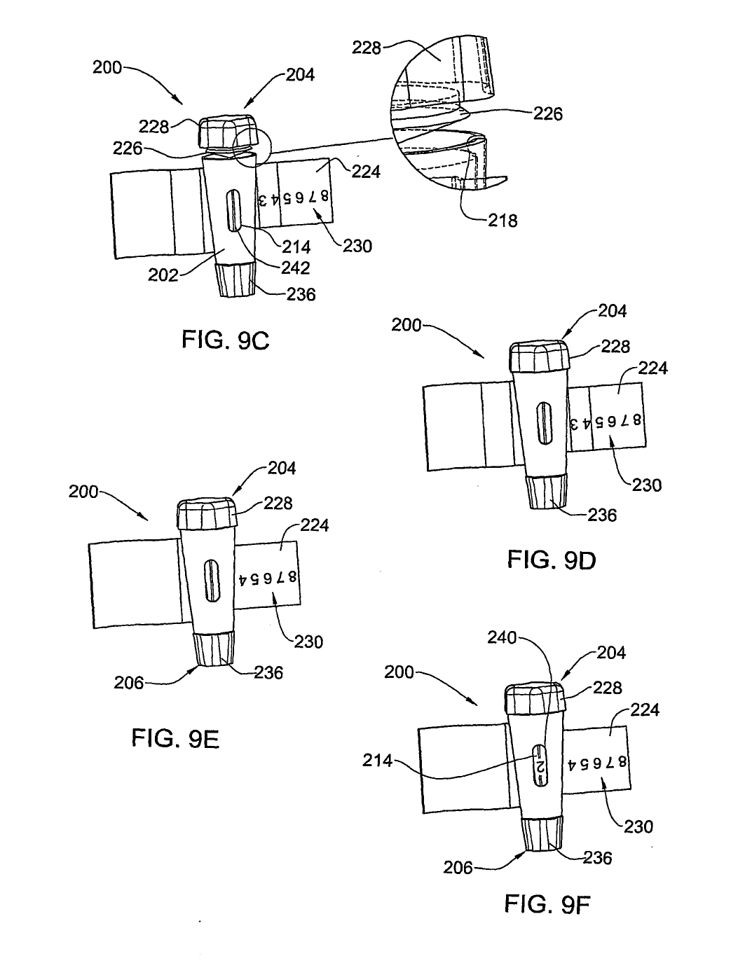

According to a modification of the invention, also illustrated in the embodiment of FIG. 1A, the cylinder 12 is adapted for snap-connection to the tube 11 to prevent unintentional axial displacement thereof from the tube 11. For that purpose there is a cylindrical groove 24 fitted for snap-engagement with an inward projection 26 formed at an edge of the tube 11. An alternate design of a snap-connection may be seen with respect to the embodiment shown in FIG. 9C.

To elaborate further, the fastened state, securely connects the first strap 15 which is connected to the cylinder 12 to the second strap 16 which is connected to the tube 11 via the rotation adjusted fastener 10, at a desired tension between the straps.

The fastener 10 allows the selection of varied degrees of tension or laxity involving the connection between the two opposing strap-like sections or belt-like sections to be brought together. Varying the tension between the straps 15 and 16 can be achieved by slightly pulling out the knob 18 from the tube 11, in order to release the rotation adjusted fastener 10 from the snap-engagement and hence the fastened position. Then, by rotating the knob 18, the first strap 15 will wind around the male part to increase tension. After tensioning, the knob 18 can be pushed inward to return the fastener 10 to the fastened state. Detaching of the fastener 10 is achieved simply by pulling out the cylinder 12 with the articulated strap 15 from the tube 11.

The fastener 10 has the advantages of a safe fastening and quick release assembly which has ability to sustain high tension while securing straps together in fixed yet at desired tension. The tension level may be adjusted as needed and is simple to operate. In other words, it is easy to fasten and release, and to keep it secure, under pressure. The tension which is applied on the joined strap or belt, is selected by the user.

Referring to FIG. 2 a cross-sectional view of a modification of the fastener 40 across the plane ‘A’ in FIG. 1B is exemplified. According to this embodiment, at least a portion of the strap 42 that enters the tube 44 (e.g., at least the surface 46 of the strap facing the inner surface of the tube 44) is fitted with a high friction texture, and the inner surface 48 of the tube 44 includes pliable teeth 50. The teeth 50 are configured to allow the rotation of the cylinder 52 in one direction only (shown by the arrow 54). This provision can help the user to fasten the straps 42 and 56. It should be noted that the teeth 50 are optional and when not present the fastener 40 may be fastened or loosened as desired by clockwise or counterclockwise rotation.

The straps 42 and 56 of the fastener 40, are made of an elastic material. However, it should be noted that the straps 42 and 56 may be made of any suitable material or fabric such as: woven fabric, polyester, non-woven, synthetic leather, nylon and similar materials.

The first strap 42 of the cylinder 52 and the second strap of the tube 44, respectively, may be integrated thereto e.g. in a molding process or attached thereto by stitching, welding etc. However, according to another particular embodiment, attachment of one or both straps to their respective member is by forming an end of the respective strap with a lateral projection (42A and 56A, respectively), being broader than a longitudinal groove 58 and 60 formed in the cylinder 52 and tube 44, respectively, such that once received within the grooves, as illustrated in the drawing, the straps can not retract.

It should be appreciated that the fastener of the present invention is an ideal means for use in any appliance or item of clothing where various buckles may be used. Such appliances, and garments and particularly those characterized by connecting belts or leather straps, or various types of straps or belts such as those used for trousers, shoes, luggage accessories, wrist watches, shirts, sweaters, suspenders, and shoes etc.

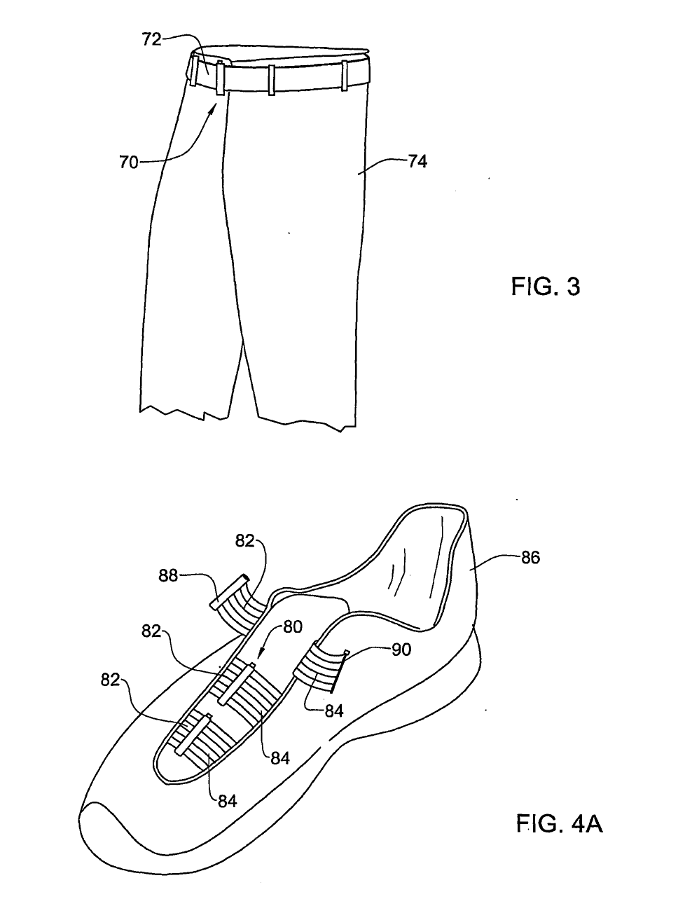

For example, FIG. 3 illustrates the utilization of the fastener according to the present invention, generally designated 70 for fastening a belt 72 for trousers 74.

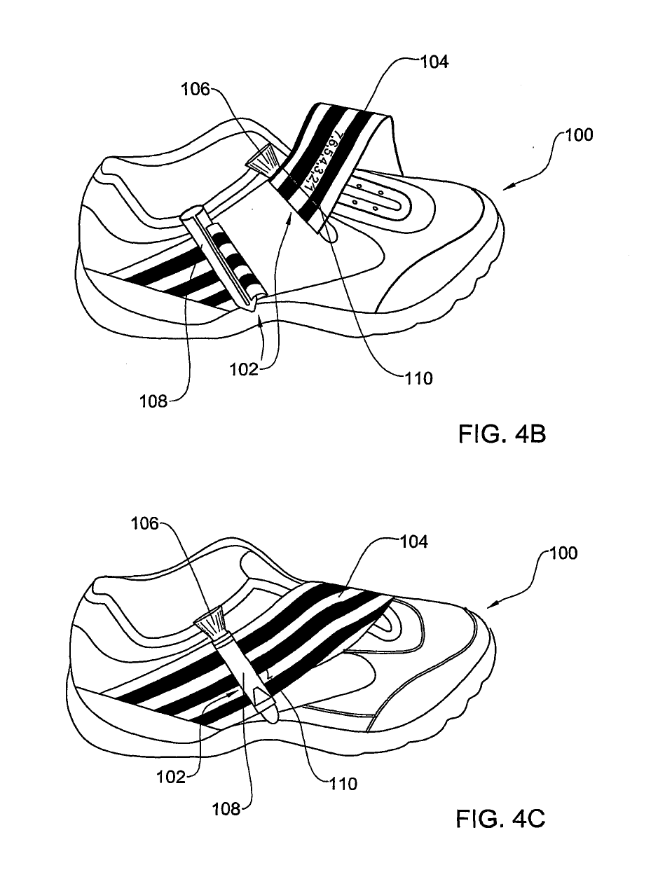

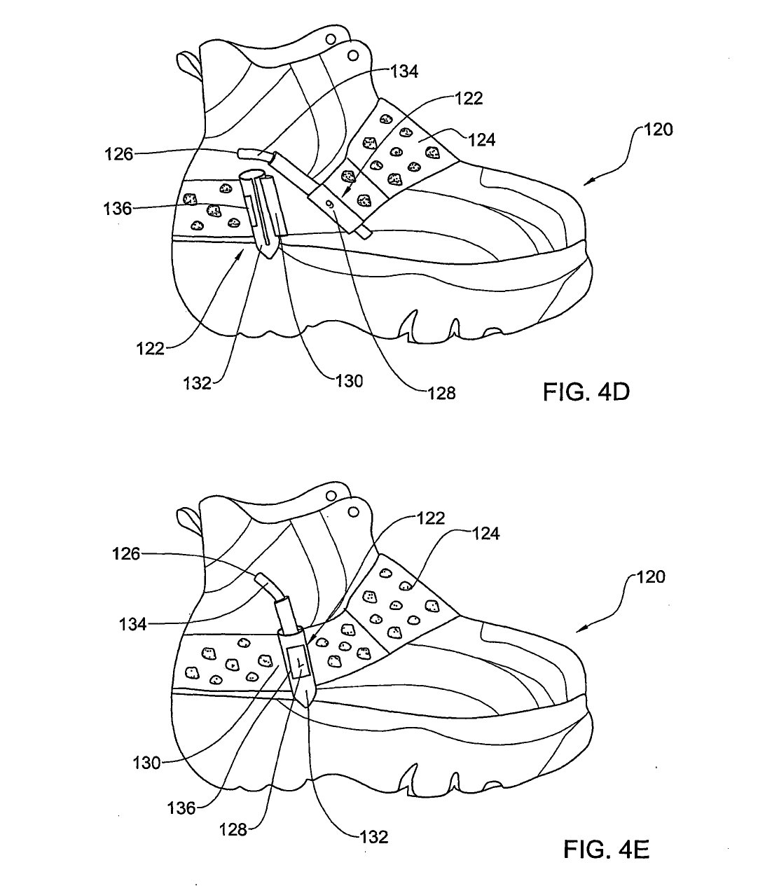

FIG. 4A illustrates an example of utilization of the rotation adjusted fastener 80 for fastening straps 82 and 84, of a shoe 86, each of straps 82 and 84 being articulated to a tube member (female part) 88 and a cylinder member (male part) 90, respectively.

Further embodiments of a rotation adjusted fastener fastened to different shoes are shown in FIGS. 4B-4E, for illustrating some modifications of the fastener according to the present invention.

In FIGS. 4B and 4C there is shown a sports shoe 100 (also known as a sneaker) comprising an alternate example of a rotation adjusted fastener 102 having a first strap 104 with a cylinder member (male part) 106 attached thereto, and a tube member (female part) 108 attached to the upper of the shoe with the strap portion extending therefrom being stitched to the upper of the shoe. In this example the first strap 104 further comprises a tension indicator 110 in the form of a numerical scale, visible on the first strap 104.

As can be seen in FIG. 4C, when the fastener 102 is in its fastened and tensioned position, a numeral of the numerical scale 110, in this case the numeral “7”, appears adjacent the slit (not shown) of the tube member 108 indicating the level of tension applied. Notably, the numeral is upside down with respect to the orientation of the shoe so that a wearer can easily read it. Understandably, a user (not shown) may fasten the fastener 102 to a different tension where multiple numbers may be seen and in such case the number closest to the rotation adjusted fastener 102 may be the appropriate tension indication.

In FIGS. 4D and 4E, a more rugged heavy-duty shoe 120 in the form of a military-style boot is shown with another example of a rotation adjusted fastener 122. The shoe 120 comprises a first strap 124 fitted with a cylindrical member (male part) 126 and having a tension indicator 128 in the form of a numerical scale, visible on an under-face of the first strap 124. A second strap 130 is fitted with female part in the form of a tube 132. The tube 132 comprises a display window 136 made of magnifying glass to enable reading the numerical scale 128 when the fastener 122 is in its fastened state. It should be noted that the tension indicator may display the relative tension existing between the two connected straps 124 and 130 by means of a color scale, pictorial scale, word scale etc. Additionally, it should be noted that the male part 126 is formed with a bent knob 134 i.e. bent with respect with a longitudinal axis of the cylinder 126, for ease of winding.

The scale numerals may be applied on either face of the strap 124, (depending on the winding direction) and the window may be formed with a shutter (not shown) to conceal the scale 128.

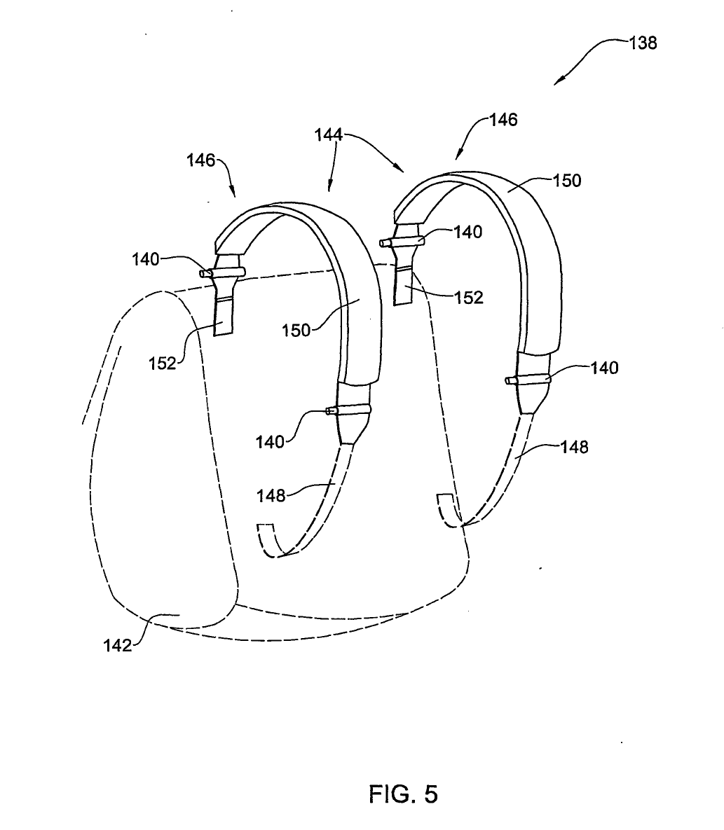

The fasteners may also be used to detachably attach objects to other objects. Referring to FIG. 5, a there is illustrated a backpack 138 comprising four fasteners 140, of the type described above. The backpack 138 includes a bag 142 having one or more storage compartments, and a harness 144 formed of two straps configured for securing the bag 142 on a user (not shown) carrying the backpack 138. The harness 144 includes a pair of strap assemblies 146, each including a first shoulder strap 148 coupled to a padded strap portion 150 and to the bottom of the bag 142, and a second shoulder strap 152 coupled to a padded strap portion 150 and to the top of the bag 142. The first shoulder strap 148 and second shoulder strap 152 are coupled to the padded strap portion 150 via two length adjustment fasteners 140 of the type discussed in connection with any of the previous embodiments. The fasteners 140 are operable to adjust the length of the shoulder straps (148 and 152) to thereby provide a comfortable fit for users of various sizes.

The above described arrangement allows a user to quickly detach and reattach the padded strap portions 150 to the backpack 138 as needed. Such need may arise if, for example, it was desired to launder the padded strap portions 150 in order to remove sweat therefrom, or if one desired to attach the padded strap portions 150 to a different object. Furthermore, the fasteners also serve to adjust the length of the straps (also at ‘fine tuning’ regime) to thereby balance the load over the users back.

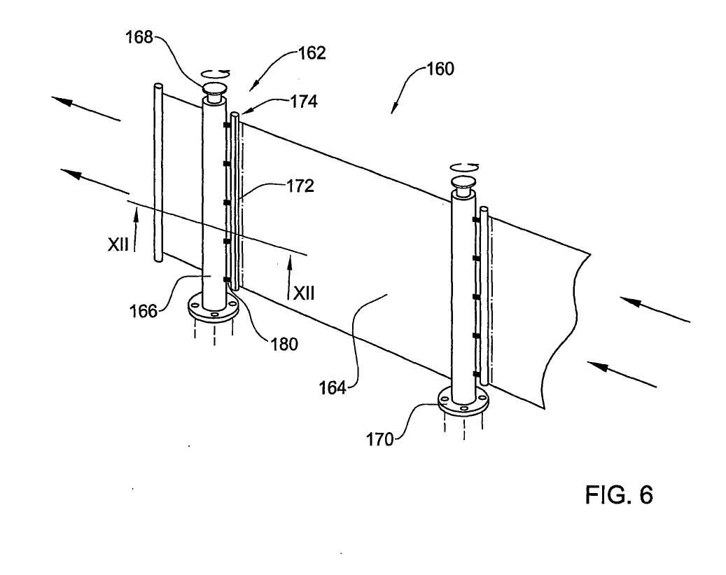

It should further be appreciated that the principle of the fastener of the present invention can be used for other applications, e.g. for creating a fence or enclosure, as disclosed with reference to FIGS. 6-8, illustrating a perspective view of a portion of an exemplary fence 160. The fence 160 includes a plurality of posts 162 connected to each other in series by rectangular sheets (constituting straps) 164 composed of a flexible material. The construction of the posts 162 is based on the principle of the rotation fastener of the present invention described above. Specifically, each post 162 includes a tube member 166 and a cylinder member 168. The cylinder 168 has a diameter smaller than the inner diameter of the tube 166, to provide that the cylinder 168 can easily slide into the tube 166, via a longitudinal slit (not shown) formed in the tube member 166. When required, the tube 166 can be attached to a base 170 configured for mounting the fence 160 in the vertical or another desired position.

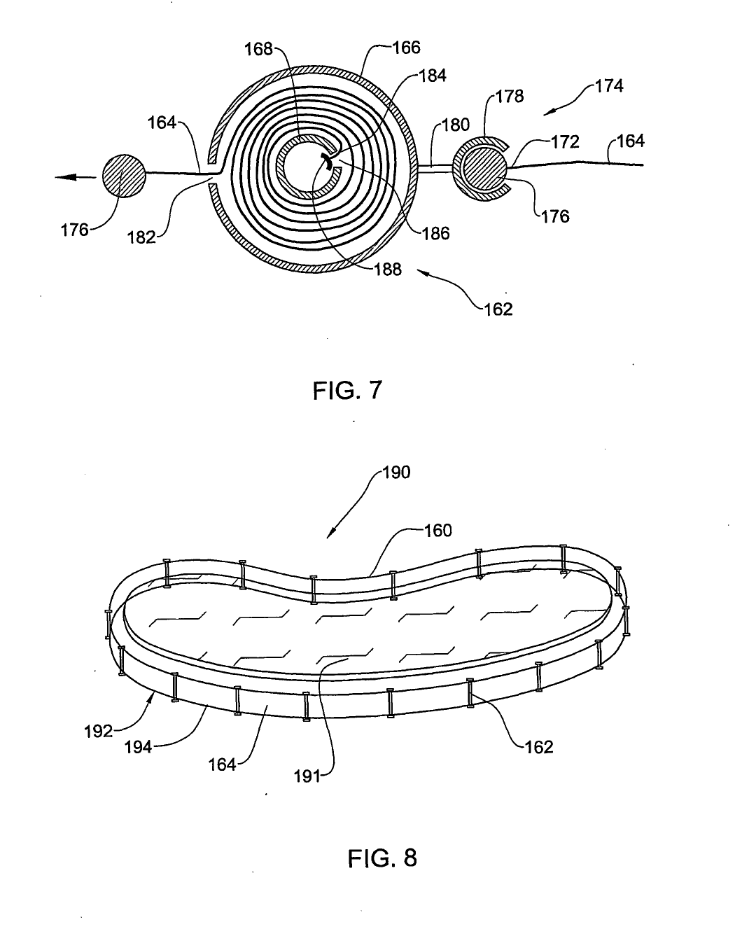

FIG. 7 shows a cross-sectional view of the post 162 according to an embodiment of the invention. An edge 172 of the rectangular sheet 164 is coupled to the tube 166 along the cylinder's wall through a buckle generally designated 174. The buckle 174 has a male part 176 and a female part 178. For example, the male part 176 has a shape of a cylinder and connected to the edge 172 along the cylinder's wall. In turn, the female part 178 can be in the trough-shaped form capable of holding the male part 176. According to this embodiment, the female part 178 is connected to the tube 166 via segment 180. The tube 166 has a longitudinal slit 182 along its wall to allow the passage of a strap 164 in the form of the rectangular sheet therethrough. It should be noted that the strap 164 may be in the form of an elastic belt or any other suitable type element which will provide the same function. Preferably, the female part 178 of the buckle 174 is connected to the tube 166 at the place which is diametrically opposite to the slit 182. Another edge 184 of the rectangular sheet 164 is anchored to the cylinder 168 via a lateral projection 188. The cylinder 168, in this example, is in a tubular form. In such a case, a groove 186 can be formed along the cylinder 168 to hold the lateral projection 188 therein.

The operation of the posts 162 is similar to the operation of the adjusted fastener, discussed hereinabove. For instance, in order to adapt the length of the fence, the rectangular sheet 164 between any two posts 162 can be rewound clockwise or counter clockwise around the corresponding cylinder 168.

Referring to FIG. 8, an example of application of the fence 160 of the present invention for building a wall of a pool 190, comprising water 191, is illustrated. The pool 190 includes the fence part 192 comprising the rectangular sheet 164 and a bottom part 194 thereof which is hermetically sealed along the circumference of the pool 190. This configuration allows for readjusting the pool size.

Referring now to FIGS. 9A-9F, there is illustrated a fastener according to a further embodiment, generally designated 200. The fastener 200 is suitable for maintaining a high tension level.

Turning attention first to FIGS. 9A and 9B, the fastener 200 comprises a tube-shaped member 202, a cylinder 204 and a locking mechanism 206.

The tube shaped member 202 includes a tapered cylindrical body 208, a second strap 210 connected to an edge of the cylindrical body 208, an opening in the cylindrical body 208 in the form of a longitudinal slit 212 and spaced from the second strap 210, a display window 214 made of magnifying glass and disposed between the slit 212 and the second strap 210, an open top-end 216, a first internal lateral projection 218 disposed adjacent to the top end 216, an open bottom end 220 and an elastic second internal lateral projection (not shown) disposed adjacent to the open bottom end 220.

The cylinder 204 comprises a cylindrical portion 222 which is connected to an edge of a first strap 224, a tapered portion 226 adapted for snapping connection to the first internal lateral projection 218, and a knob portion 228 for rotation of the cylinder 204. The first strap 224 comprises a tension indicator in the form of an inverted numeral scale 230.

The locking mechanism 206 comprises a tapered cylindrical body portion 232 having an open upper end 234 and a diameter smaller than that of the tube member 202, and an integral knob portion 236 having a larger diameter than the bottom end 220 of the tube member 202. The cylindrical body 232 further comprises an opening in the form of a longitudinal slit formed therein 238, a display window 240 spaced from the slit 238, and a position indicator in the form of a longitudinal line marking 242 on the outer surface of the body disposed between the display window 240 and the slit 238. The slit 238 has an edge formed with square teeth 244, for which purpose will be explained hereinafter. Whilst the knob 236 is integral in the locking mechanism 206 shown, it should be noted that a knob and cylindrical body which are detachably-attachable may also be used. Additionally, the square teeth 244 along the edge of the slit 238 are optionally included in this embodiment.

During assembly, the open upper end 234 of the locking mechanism 206 is inserted axially with some force into the open bottom end 220 of the tube 202. The force is needed to maneuver the locking mechanism 206 past the second internal lateral projection (not shown), which serves to normally arrest axial motion of the locking mechanism 206 with respect to the tube 202. When the knob portion 236 of the mechanism 206 reaches the bottom end 220 of the tube 202 the application of force is halted and the elastic second internal lateral projection (not shown) engages the mechanism 206, arresting axial motion but not rotational motion thereof.

Referring now to FIG. 9C, during operation, a user (not shown) rotates the knob 236 on the mechanism 206 (best seen in FIGS. 9A and 9B) so that the position indicator 242 can be seen through the display window 214 on the tube 202. When the indicator 242 is seen in the window 214, it indicates that the slits (212 and 238) of the tube 202 and the mechanism 206 respectively, are aligned (in the manner shown in FIG. 9A). The cylinder 204 is then inserted into the tube 202 and the mechanism 206, with the first strap 224 being received by both slits thereof (212 and 238). The fastener 200, in the position shown in FIG. 9C is then rotated via the knob portion 228 of the cylinder 204 (FIGS. 9A and 9B), to a moderate tension. When that moderate tension is reached the cylinder 204 is inserted fully into the tube 202, with the tapered portion 226 of the cylinder 204 snappingly connecting to the first internal lateral projection 218 of the tube 202 resulting in the fastener being assembled, as is shown in FIG. 9D, constituting the fastened state. The user (not shown) may then rotate the knob portion 228 of the cylinder 204 to reach a desired high level of tension, at least higher than the moderate tension previously reached, as shown in FIG. 9E. This higher level of tension can be noticed pictorially by contrasting the change in the number of numerals 230 visible, and the tightening of the first strap 224, in FIGS. 9D and 9E. Referring now to FIGS. 9E and 9F, without releasing the knob portion 228 of the cylinder 204, the user (not shown) may use his other hand to rotate the mechanism 206 via its knob 236 to lock the first strap 224 in position, as shown in FIG. 9F. This locking of the first strap 224 is accomplished, due to the slits (212 and 238) no longer being aligned, thus increasing the frictional force of the slits (212 and 238) against the first strap 224 and clamping it therebetween. The teeth 244 on the mechanism's slit 238 (FIGS. 9A and 9B) further aid to prevent slippage of the first strap 224 thereagainst. As seen in FIG. 9F the window 240 of the mechanism 206 is now positioned so that a user (not shown) may see the numerals of the position indicator 230. It should be mentioned that the display windows (214 and 240) and the position indicator 242 may be of alternative shapes, sizes and positions. For example the position indicator 242 may be smaller and the window 240 may be positioned there below such that the numerals 230 and position indicator 242 may be seen simultaneously through the display windows (214 and 240). For quick release, the knob 236 of the mechanism 206 is rotated so that the position indicator 242 is seen through the display window 214 and the knob portion 228 of the cylinder 204 is pulled out of the tube 206.

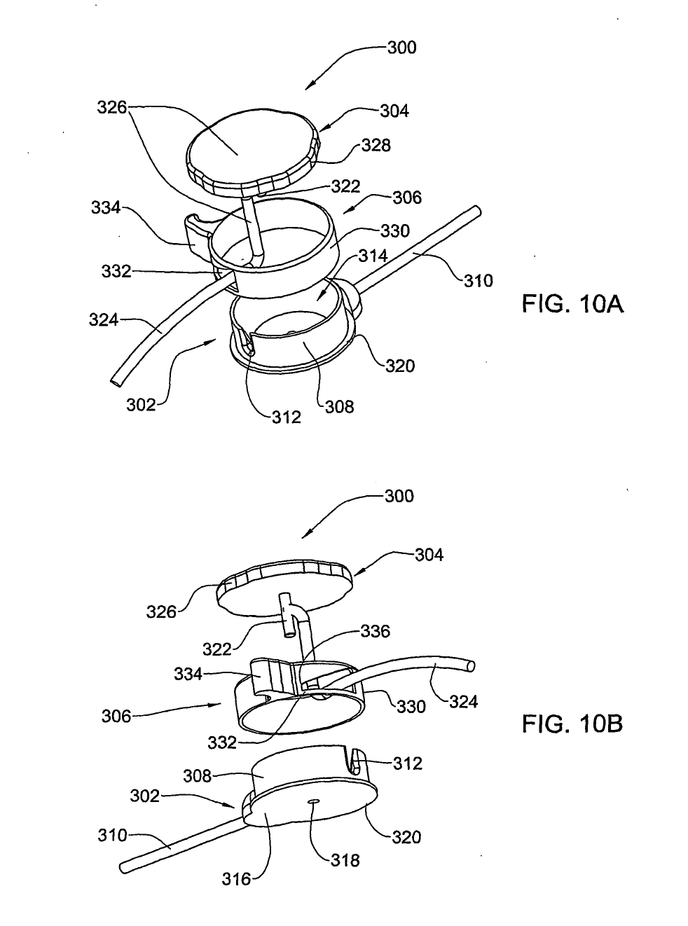

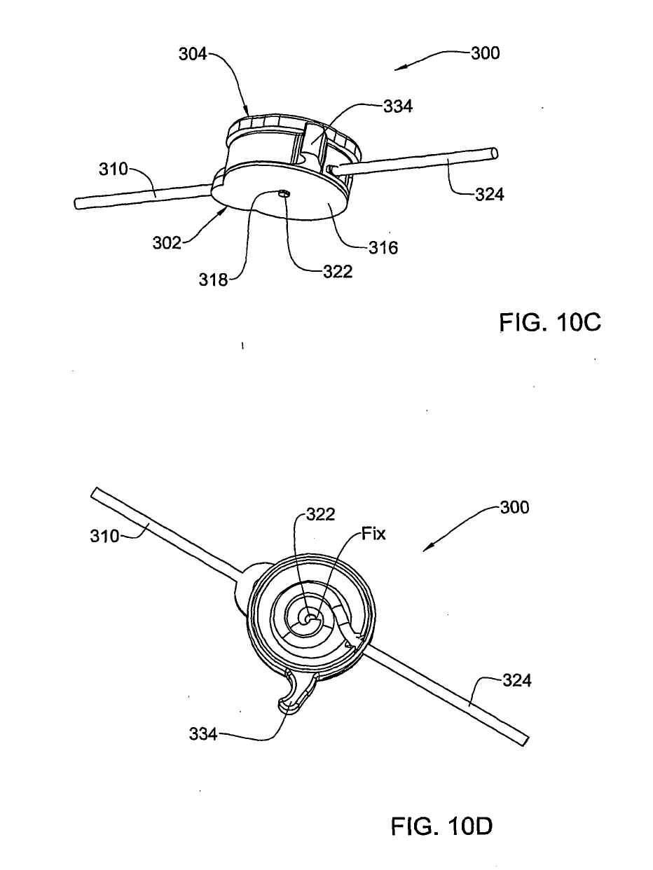

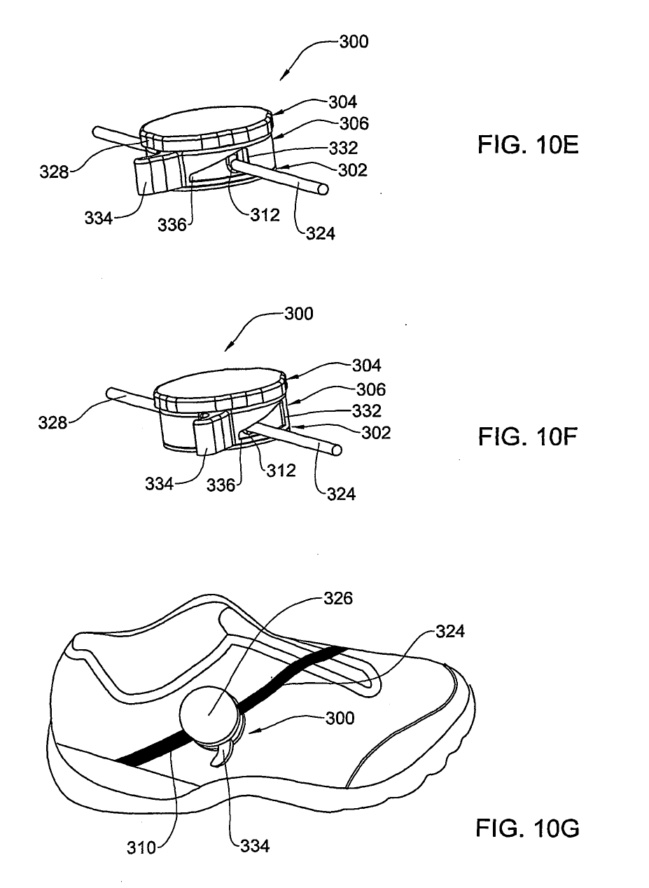

In FIGS. 10A-10G a further embodiment of a fastener is shown. In this embodiment the fastener may be smaller and lighter than in previous embodiments, with the cylindrical components having a much larger diameter to axial length ratio. Such a design may be useful, for example, for sports shoes as shown in FIG. 10G. It can be seen in FIG. 10G, that the longitudinal axis of the fastener used with the sports shoes projects in a direction normal to the outer surface thereof, in contrast to the previous examples of the fasteners shown with shoes in which the longitudinal axis of the fastener was parallel to the outer surface thereof.

Referring first to FIGS. 10A and 10B, the flat-shape fastener 300 comprises a tube-shaped member 302, a cylinder 304 and a locking mechanism 306.

The tube 302 includes a substantially cylindrical body 308, a cord-shaped second strap 310 connected to an edge of the cylindrical body 308, an opening formed within the sidewall of the cylindrical body in the form of a longitudinal slit 312 spaced from the second strap 310, an open top-end 314, a closed bottom end 316 having a central aperture 318 formed therein and a seat portion in the form of an external annular projection 320.

The cylinder 304 comprises a cylindrical knob portion 322 adapted to fit inside the central aperture 318 of the tube 302 and connected to an edge of a cord-shaped first strap 324 (best seen in FIG. 10B), and a knob portion 326 for rotation of the cylinder 304 via a gripping rim 328, having a larger diameter than the locking mechanism 306.

The locking mechanism 306 comprises of an open-ended cylindrical body 330 having a triangular slot 332 formed therein and a lateral knob portion 334 laterally formed with an outer surface of the cylindrical body 330. The slot 332 tapers to a corner 336 (FIG. 10B), for reasons which will be explained hereinafter. The cylindrical body 330 of the mechanism 306 has a diameter larger than the cylindrical body 308 of the tube member 302 such that it may slide thereover and sit on the external annular projection 320 thereof, without restricting rotational movement of the tube 302.

As can be seen in FIGS. 10A and 10B, the first strap 324 is intended to be inserted through the triangular slot 332 and to be received inside the longitudinal slit 312.

Referring now to FIG. 10C, when the fastener 300 is assembled the cylindrical knob portion 322 fits inside the central aperture 318 of the tube 302 allowing the cylinder 304 to be rotated in a stable manner.

Referring now to FIGS. 10C and 10D, during operation, a user (not shown) rotates the knob portion 322 of the cylinder 304, via the gripping rim 328 thereof, in either direction. The rotation causes the first strap 324 to wind around the cylindrical knob portion 322, thus tensioning the straps (310 and 324).

Turning attention now to FIGS. 10E and 10F, to maintain a desired tension, the user rotates the locking mechanism 306 counterclockwise, via the lateral knob portion 334 so that the first strap 324 is moved towards the corner 336 and consequently “locked” in position by being caught between the tapering slot 332 and the edge of the longitudinal slit 312 within which it is received. This locking action via the slot 332 edge and slit 312 works in a similar manner to that described in the last embodiment of the fastener 200. For quick release of the fastener 300, the user (not shown) rotates the locking mechanism 304 clockwise to unlock the fastener 300, and pulls the cylinder 304 out of the tube via the gripping rim 328. Ideally, the locking mechanism 304 stays attached to the tube 302 and the first strap 324 remains threaded through the slot 332. Thus the cylinder 304 remains conveniently close to the other portions of the fastener 300.

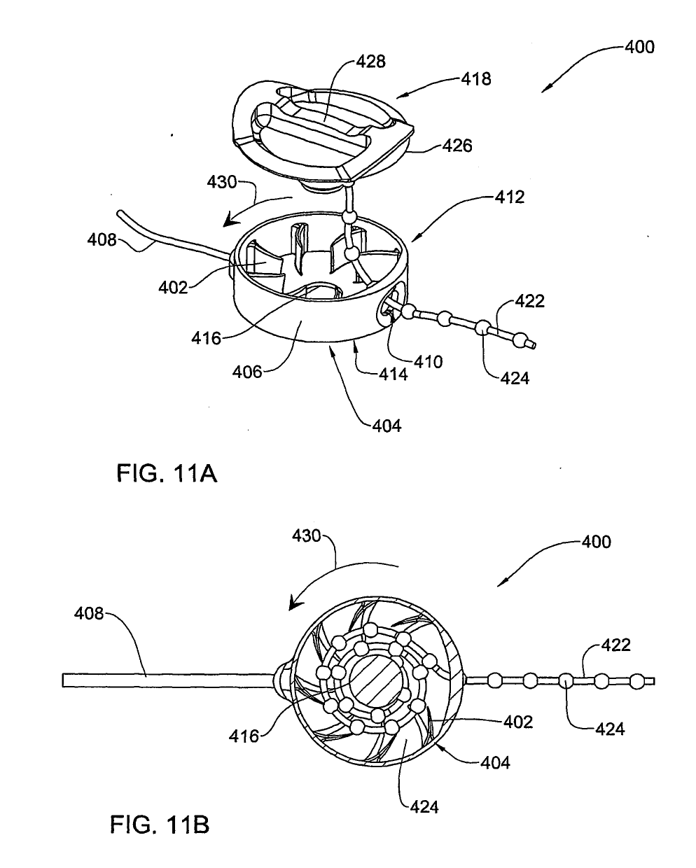

In FIGS. 11A and 11B another embodiment of a fastener, generally designated 400, is shown comprising a locking mechanism in the form of pliable teeth 402, formed on the inner surface of the tube member 404. The teeth 402 are similar to those described with reference to FIG. 2.

The tube shaped member 404 includes a sidewall 406, a cord-shaped second strap 408 connected to an edge of the sidewall 406, an opening formed within the sidewall 406 in the form of an aperture 410 spaced from the second strap 408, an open top-end 412, and a closed bottom end 414 (FIG. 11B) having a central aperture 416 formed therein.

The cylinder 418 comprises a cylindrical knob portion 420 adapted to snappingly connect to the central aperture 416 of the tube 404. The cylindrical knob portion 420 is connected to an edge of a cord-shaped first strap 422 having periodic bulging portions 424, and a top knob portion 426 for rotation of the cylinder 418 having a larger diameter than the tube 404 and a transverse bar 428 for gripping the cylinder 418.

During operation, the fastener 400, when in fastened position (i.e. when the cylinder 418 is mounted on the tube 404 via the cylindrical knob portion 420 being snappingly connected to the central aperture 416), may only be tensioned by rotation of the tope knob portion 426 in the direction of arrow 430. The teeth 402 and bulging portions 424 on the first strap 422 arrest the cylinder 418 from rotation in the opposite direction of arrow 430. For quick release, the user (not shown) simply grips the transverse bar 428 and pulls the cylinder 418 out of the tube 404.

Those skilled in the art to which this invention pertains will readily appreciate that numerous changes, variations and modifications can be made without departing from the scope of the invention mutatis mutandis.

1. A fastener for joining a first strap section and a second strap section, the fastener comprising: a cylindrical member connected to said first strap section along the cylinder's wall, a tube-shaped member connected to said second strap section along the tube's wall and having an inner diameter larger than the diameter of the cylinder such that the cylinder is insertable into a lumen of the tube and rotatable there inside, the tube having an opening formed within its wall to allow the passage of the first strap therethrough, whereby the first strap section is attached to the second strap section by inserting the cylinder in the tube, wherein the fastener is adapted to be brought to a fastened state in which the first strap and second strap are connected via the fastener at a desired tension and an unfastened state in which the first strap and second strap are separated.

2. The fastener of claim 1, further including at least one knob arranged at one end of the cylinder for providing a manual rotation thereof to wind the first strap around a longitudinal axis of the cylinder, thereby reducing the redundant extra length of the first strap as it is getting wrapped around the cylinder, and increasing the ongoing tension between the joined first and second straps.

3. The fastener of claim 2, wherein at least a portion of the at least one knob is tapered for locking said length adjustment fastener when the cylinder is inserted in the tube, and is adapted for snapping connection to the tube.

4. The fastener of claim 1, adapted to be brought to the unfastened state by pulling the cylinder axially out of the tube.

5. The fastener of claim 1, further comprising a tension indicator comprises a scale for displaying the associated tension and length between the first strap section and second strap section.

6. The fastener of claim 5, wherein said scale is a numerical scale or color scale or pictorial scale or word scale.

7. The fastener of claim 5, wherein the numerical scale is oriented in accordance to the object that the fastener is attached to, to facilitate reading thereof.

8. The fastener of claim 5, wherein said fastener further comprises a display window for viewing the scale.

9. The fastener of claim 8 wherein the display window is made of magnifying glass.

10. The fastener of claim 1, wherein at least a portion of the first strap has a high friction texture, and the inner surface of the tube includes pliable teeth allowing the rotation of the cylinder in one direction only.

11. The fastener of claim 10, wherein the high friction texture is in the form of periodic bulging portions.

12. A piece of garment comprising the fastener of claim 1.

13. A fence of an adjustable length, the fence comprising an array of spaced-apart posts connected to each other via straps in the form of substantially rectangular sheets, each of said posts being configured as the fastener of claim 1.

14. The fence of claim 10, wherein said fence constitutes the wall of a pool and further comprises a bottom part which is hermetically sealed along the circumference of the bottom part.

15. A harness comprising the fastener defined in claim 1.

16. A shoe comprising the fastener adjacent to a surface thereof, as defined in claim 1.

17. The shoe of claim 16, wherein said fastener is adapted for it's longitudinal axis to be parallel to the adjacent surface of said shoe.

18. The shoe of claim 16, wherein said fastener is adapted for it's longitudinal axis to project in a normal direction to the adjacent surface of said shoe.

19. An object comprising at least two fasteners, of the type defined in claim 1, wherein the fasteners are disposed in an arrangement which allows the object to be detachably attached between two other items via the fasteners.

20. A fastener according to claim 1, wherein said fastener is adapted to be used with clothing such as belts or shoes or other similar constructions which comprise strap-like portions that require tensioning.

21. A fastener according to claim 1, further comprising a locking mechanism for maintaining or assisting to maintain the fastener in a tensioned-fastened state.

22. A fastener according to claim 19, wherein said locking member is a rotatable member disposed on the inside or the outside of the tube.

23. A fastener according to claim 20, wherein said locking mechanism further comprises an opening formed therein for the first strap to pass therethrough.

24. A fastener according to claim 21, wherein said opening of the locking member is a slit or an aperture.

25. A fastener according to claim 21, wherein said opening of the locking member is tapered to a corner thereof.

26. A fastener according to claim 21, wherein said opening of the locking member further comprises teeth, for increasing friction when the first strap is clamped thereagainst by the opening of said tube.

27. A fastener according to claim 19, wherein said locking member further comprises display window.

28. A fastener according to claim 19, wherein said locking member further comprises a position indicator.

29. A fastener according to claim 27, wherein said position indicator is a line marking.

30. A fastener according to claim 19, wherein said locking member is in the form of pliable teeth, formed on the inside of said tube.

31. A fastener according to claim 19, wherein said locking member further comprises a knob for locking said fastener when the cylinder is inserted in the tube.
